(19) United States
(12) Patent Application Publication
(10) Pub. No.: US 2025/0146675 A1
(43) Pub. Date: May 8, 2025

(54) SELF-ASSEMBLY HOT WATER MAT WITH PARALLEL FLOW

(71) Applicant: J&C TRADING CO., LTD., Chungju-si, Chungcheongbuk-do (KR)

(72) Inventor: Jung-Nam KIM, Seoul (KR)

(21) Appl. No.: 18/555,276

(22) PCT Filed: Apr. 28, 2023
(86) PCT No.: PCT/KR2023/005911

§ 371 Date: Jan. 27, 2025

(30) Foreign Application Priority Data
Dec. 15, 2022 (KR) 10-2022-0175899
Feb. 28, 2023 (KR) 10-2023-0026549

(51) Int. Cl. F24D 3/14; F24D 3/12

(52) U.S. Cl. CPC F24D 3/146; F24D 3/125

(57) ABSTRACT

Disclosed is a self-assembly hot water mat, which forms an M×N matrix (M and N are natural numbers of 1 or more) by assembling at least two unit hot water mats. The self-assembly hot water mat forms a parallel hot water flow including the N number of serial heating flow paths (each branch hot water flow path having the M number of heating pipes), in which the hot water introduced in the first direction through the hot water boiler is converted into the second direction, then is divided into the N number of branch flow paths to flow in the first direction according to a predetermined pattern, and then is collected in the second direction and returned to the hot water boiler.

### TECHNICAL FIELD

The present application claims priority to Korean Patent Application No. 10-2022-0175899 filed on Dec. 15, 2022 in the Republic of Korea and Korean Patent Application No. 10-2023-0026549 filed on Feb. 28, 2023 in the Republic of Korea, the disclosures of which are incorporated herein by reference.

The present disclosure relates to a hot water mat capable of heating, and more specifically, to a self-assembly hot water mat that may be expanded through assembly and has parallel flow.

### BACKGROUND ART

Ondol is a traditional Korean heating method that warms the floor. In the Ondol, a pipe is installed inside the floor, and hot water circulates through this pipe to heat the floor.

The Ondol incurs high initial construction costs, and when installing the Ondol in a place where the floor has been constructed, even more costs may be incurred than the initial cost. Accordingly, in order to use the Ondol at low cost, hot water mats are being produced and distributed on the market.

A conventional hot water mat as disclosed in Patent Literature 1 (Korean Unexamined Patent Publication No. 2014-0049395) is released in the form of a bed matrix or blanket, and has a problem in terms of space since it can only be used in a narrow space. In addition, the conventional hot water mats operate independently of each other, so there is a problem in the space expansion (i.e., the expansion of the Ondol area).

In order to solve these problems of the prior art, a self-assembly hot water mat has been proposed that allows assembling various types of heating panels to create an optimal pattern according to space.

Patent Literature 2 (Japanese Unexamined Patent Publication No. 2002-228170) discloses a heating panel that can be used as a floor heating panel by combining and laying several panels P. Referring to FIG. 1, the panel P has a square or rectangular shape. A pair or multiple pairs of input/output connectors 1 are provided on four sides of the panel P, so that hot water may flow in or out of the panel at the four sides, respectively. In addition, a plurality of changeable connectors 2 are arranged inside the panel P, so that the direction of a heat dissipation pipe 3 connected to each input/output connector 1 may be changed inside the panel P. Therefore, a self-assembly heating panel as shown in FIG. 2 may be completed by assembling several panels of FIG. 1 with several basic patterns. In other words, a total of 9 heating panels are formed to include three panels with a first pattern P1, two panels with a second pattern P2, one panel with a third pattern P3, and three panels with a fourth pattern P4.

Meanwhile, referring to FIG. 3, Patent Literature 3 (US 2011/0073274 A1) discloses a self-assembly heating panel in which three panels are assembled to heat a large area through hot water.

In addition, Patent Literature 4 (Korean Patent No. 10-2046630) filed by and allowed to the inventor of this application discloses a hot water mat assembled in a 3×4 arrangement as shown in FIG. 4. Referring to FIG. 4, a total of 12 self-assembly hot water mats are assembled through a plurality of expansion connectors. Therefore, the hot water supplied from the hot water boiler 10 circulates through the main pipe of the first self-assembly hot water mat 100, the third bypass pipe and the main pipe of the second self-assembly hot water mat 200, the third bypass pipe and the main pipe of the third self-assembly hot water mat 300, the third bypass pipe, the main pipe and the branch pipe of the fourth self-assembly hot water mat 400, the main pipe, the first bypass pipe and the branch pipe of the eighth self-assembly hot water mat 800, the main pipe and the first bypass pipe of the twelfth self-assembly hot water mat 1200, the main pipe of the eleventh self-assembly hot water mat 1100, the branch pipe, the first bypass pipe, the main pipe and the second bypass pipe of the seventh self-assembly hot water mat 700, the second bypass pipe, the eleventh self-assembly hot water mat 1100, the main pipe of the tenth self-assembly hot water mat 1000, the branch pipe, the first bypass pipe, the main pipe and the second bypass pipe of the sixth self-assembly hot water mat 600, the second bypass pipe of the tenth self-assembly hot water mat 1000, the main pipe of the ninth self-assembly hot water mat 900, the branch pipe, the first bypass pipe and the main pipe of the fifth self-assembly hot water mat 500, and the second bypass pipe of the first self-assembly hot water mat 100, and then collected again in the hot water boiler 10.

### DISCLOSURE

### Technical Problem

The self-assembly hot water mats of the Patent Literatures 2 to 4 all have a serial flow in which hot water discharged from the hot water boiler circulates through several hot water mats in order and returns to the hot water boiler.

Thus, it take a long time for the hot water to be supplied to all hot water mats, and the temperature of the last hot water returning to the hot water boiler is lowered, resulting in lower energy efficiency.

Meanwhile, Patent Literature 2 in FIG. 1 must include at least eight input/output connectors and four change connectors in one hot water mat, and Patent Literature 3 in FIG. 3 must include at least eight female connectors and male connectors in one hot water mat. Also, Patent Literature 4 of FIG. 4 must include eight open/close valves and six bypass valves.

In this way, in the conventional self-assembly hot water mat with serial flow as disclosed in Patent Literatures 2 to 4, in order to make a serial hot water flow using several hot water mat, a plurality of valves, connectors, quick disconnect coupling, etc. must be attached, which causes the overall cost of the hot water mat to increase.

In addition, in order to convert the serial flow of the conventional self-assembly hot water mat into a parallel flow, a hot water boiler with enough power to simultaneously pump and circulate hot water to a plurality of hot water mats must be developed. However, in this case, as the power of the hot water boiler increases, new problems such as reduced energy efficiency as well as side effects such as noise arise.

Therefore, the present disclosure is firstly directed to providing a self-assembly hot water mat with parallel hot water flow, which has low noise and high energy efficiency.

In addition, the present disclosure is secondly directed to providing a self-assembly hot water mat with parallel hot water flow, which may minimize costs by minimizing the number of valves or installed connectors without additionally increasing the power of the hot water boiler by improving the hot water flow path of the unit hot water mat.

These and other objects and advantages of the present disclosure may be understood from the following detailed description and will become more fully apparent from the exemplary embodiments of the present disclosure. Also, it will be easily understood that the objects and advantages of the present disclosure may be realized by the means shown in the appended claims and combinations thereof.

### Technical Solution

According to an aspect of the present disclosure to solve the above technical object, there is provided a unit hot water mat of a self-assembly hot water mat, which forms a parallel flow by assembling at least two unit hot water mats, the unit hot water mat comprising: a heating pipe arranged in a predetermined pattern to heat a surface of the unit hot water mat by passing a hot water inflowed from a hot water boiler in the predetermined pattern; a first main pipe configured to flow the hot water inflowed from the hot water boiler to a first direction; a second main pipe connected to the heating pipe to flow the hot water from the first direction to a second direction and deliver the hot water to the heating pipe; a return pipe installed to be spaced apart from the second main pipe by a predetermined distance in the first direction and connected to the heating pipe to flow the hot water circulated through the heating pipe to the second direction and return to the hot water boiler; and a bypass pipe configured to connect the first main pipe and the second main pipe to convert the hot water having the first direction to hot water having the second direction, and the heating pipe is formed in a separated space between the second main pipe and the return pipe.

According to the second aspect of the present disclosure, the unit hot water mat according to the first aspect may further comprise a first connected pipe connected in the first direction to the return pipe and a second connected pipe connected in the first direction to the second main pipe to form a serial hot water flow path between heating pipes of unit hot water mats adjacent to each other in the first direction.

According to the third aspect of the present disclosure, in the unit hot water mat according to the second aspect, the bypass pipe converts the hot water having the first direction in the first main pipe into the hot water having the second direction in the second main pipe by connecting the first main pipe and the second connected pipe.

According to the fourth aspect of the present disclosure, the unit hot water mat according to the third aspect may further comprise an ON/OFF valve installed at both ends of the first main pipe, both ends of the second main pipe, both ends of the return pipe, and an end of the first and second connected pipes, respectively, and the ON/OFF valve opens a flow path by coupling two corresponding ON/OFF valves.

According to the fifth aspect of the present disclosure, in the unit hot water mat according to the fourth aspect, a connection connector is installed on the bypass pipe to open or close the hot water flow path.

According to the sixth aspect of the present disclosure, in the unit hot water mat according to the fifth aspect, the first direction and the second direction are perpendicular to each other.

According to the seventh aspect of the present disclosure, in the unit hot water mat according to the sixth aspect, the first connected pipe is directly connected to the hot water boiler.

According to the eighth aspect of the present disclosure, in the unit hot water mat according to the seventh aspect, the heating pipe is arranged in a zigzag pattern along the first direction at a center of the unit hot water mat between the second main pipe and the return pipe.

According to the ninth aspect of the present disclosure, in the unit hot water mat according to the seventh aspect, the unit hot water mat is a rectangular, the first main pipe is installed in the first direction which is a long side direction of the rectangle, and the second main pipe and the return pipe are installed in the second direction which is a short side direction of the rectangle to be spaced apart by a predetermined distance from each other.

According to the tenth aspect of the present disclosure, in the unit hot water mat according to the ninth aspect, a pair of ON/OFF valves are installed on each of four sides of the rectangular.

According to the eleventh aspect of the present disclosure, there is provided a self-assembly hot water mat with a parallel flow, which forms an M×N matrix array (M and N are natural numbers of 1 or more) by assembling at least two unit hot water mats according to any one of the fifth to tenth aspects, wherein a main hot water flow path having the first direction is formed by coupling the ON/OFF valves installed at both ends of the first main pipe of unit hot water mats that constitute the 1^{st} column of the M×N matrix, wherein the ON/OFF valve installed at one end of the first main pipe of the unit hot water mat at the Mth row and the 1^{st} column is connected to the hot water boiler, wherein a main hot water flow path having the second direction is formed by coupling the ON/OFF valves installed at both ends of the second main pipes of unit hot water mats that constitute the 1^{st} row of the M×N matrix, wherein a return hot water flow path having the second direction is formed by coupling the ON/OFF valves installed at both ends of the return pipes of unit hot water mats that constitute the Mth row of the M×N matrix, wherein the ON/OFF valve installed at one end of the first connected pipe of the unit hot water mat at the Mth row and the 1^{st} column is connected to the hot water boiler, and wherein a bypass hot water flow path is opened by coupling only the connection connector installed on the bypass pipe of the unit hot water mat at the 1^{st} row and the 1^{st} column.

According to the twelfth aspect of the present disclosure, in the self-assembly hot water mat with a parallel flow according to the eleventh aspect, the hot water flowing through the main hot water flow path having the first direction inflowed from the hot water boiler is converted to the hot water flowing through the main hot water flow path having the second direction, then is divided into the n (n is a natural number of 2 or more) number of branch flow paths to flow in the first direction according to the predetermined pattern, and then is collected in the second direction and returned to the hot water boiler.

According to the thirteenth aspect of the present disclosure, in the self-assembly hot water mat with a parallel flow according to the twelfth aspect, each of the n number of branch hot water flow paths is formed a serial heating flow path in which the m (m is a natural number of 1 or more) number of heating pipes are connected in series.

According to the fourteenth aspect of the present disclosure, in the self-assembly hot water mat with a parallel flow according to the thirteenth aspect, the M×N matrix array forms a parallel hot water flow by connecting a N number of serial heating flow paths, in which a M number of heating pipes are connected in series, to each other in parallel.

### Advantageous Effects

In the self-assembly hot water mat according to the present disclosure, since hot water mats may be coupled in any of the four sides, the Ondol area may be easily expanded, and installation costs incurred in constructing the Ondol may be minimized.

In addition, the parallel hot water flow of the self-assembly hot water mat according to the present disclosure may reduce the time of one heating circulation cycle compared to the conventional serial hot water flow, thereby maximizing the circulation efficiency of hot water.

In addition, in the present disclosure, since the hot water flow path of the unit hot water mat is improved, the power of the hot water boiler is not increased, thereby stabilizing household noise. Also, the cost of the hot water mat may be reduced by minimizing the number of installed valves or connectors.

### DESCRIPTION OF DRAWINGS

The accompanying drawings illustrate a preferred embodiment of the present disclosure and together with the foregoing disclosure, serve to provide further understanding of the technical features of the present disclosure, and thus, the present disclosure is not construed as being limited to the drawing.

FIG. 1 is a schematic plan view showing a heating panel in Patent Literature 2.

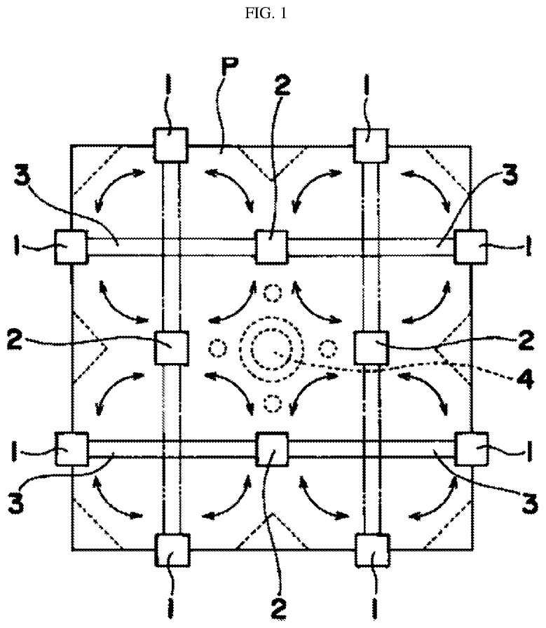

FIG. 2 is a schematic plan view showing an example of the assembled heating panel in Patent Literature 2.

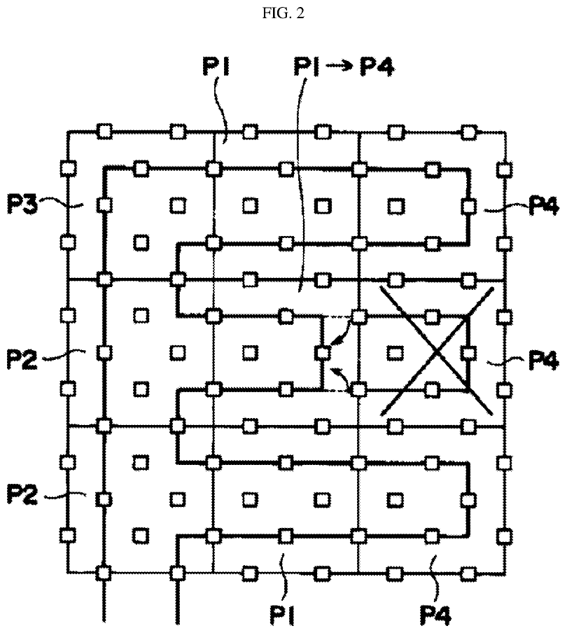

FIG. 3 is a schematic plan view showing an example of an assembled heating panel in Patent Literature 3.

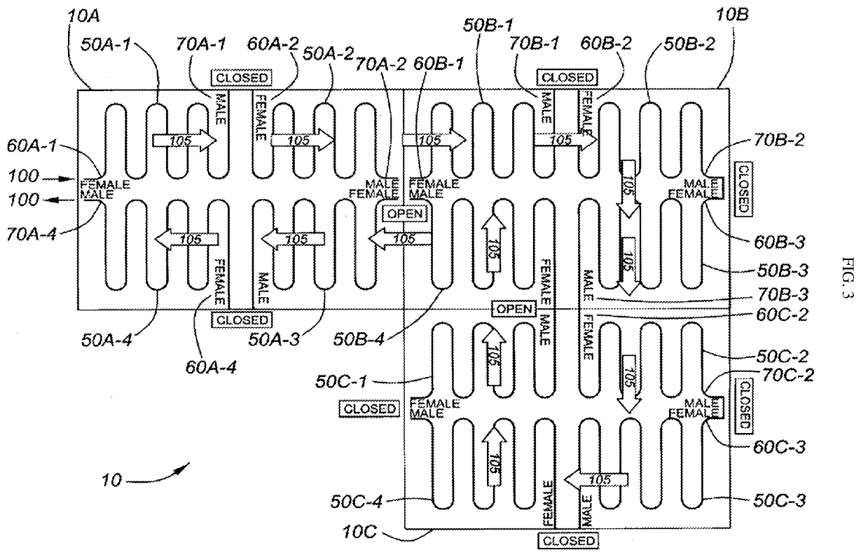

FIG. 4 is a drawing showing the flow of hot water in a hot water mat assembled in a 3×4 array in Patent Literature 4.

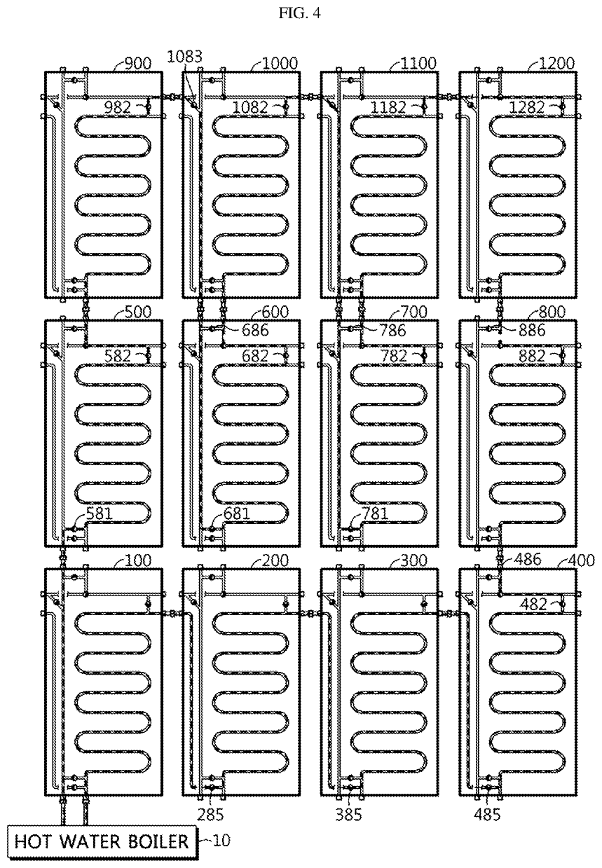

FIG. 5 is a schematic plan view showing a self-assembly hot water mat according to a preferred embodiment of the present disclosure in which two unit mats are coupled.

FIG. 6 is a schematic plan view showing a self-assembly hot water mat according to the present disclosure in which unit hot water mats P₁ to P₆ are assembled into a 3×2 matrix.

FIG. 7 is a schematic plan view showing a self-assembly hot water mat according to the present disclosure in which fifteen unit hot water mats are assembled into a 3×5 matrix.

### BEST MODE

The present disclosure can make various changes and have several embodiments, so specific embodiments will be illustrated in the drawings and explained in detail. However, this is not intended to limit the present disclosure to a specific embodiment, and should be understood to encompass all changes, equivalents, or substitutes included in the idea and technical scope of the present disclosure.

When a component is mentioned to be “connected” or “contacted” to another component, it should be understood that the corresponding component can be directly connected or contacted to the other component, but an additional component may exist between them.

Meanwhile, when it is mentioned that a component is “directly connected” or “directly contacted” to another component, it should be understood that there is no other component between them.

The terms used in this specification are merely used to describe specific embodiments and are not intended to limit the present disclosure. Singular expressions include plural expressions, unless the context clearly indicates otherwise. In this application, terms such as “comprise” or “have” are intended to designate the presence of features, numbers, processes, operations, components, parts, or combinations thereof described in the specification, and it should be understood that this does not exclude in advance the possibility of the existence or addition of one or more other features, numbers, processes, operations, components, parts, or combinations thereof.

Unless otherwise defined, all terms used herein, including technical or scientific terms, have the same meaning as commonly understood by those skilled in the art. Terms defined in commonly used dictionaries should be interpreted as having a meaning consistent with the meaning in the context of the related technology, and unless clearly defined in this specification, they should not be interpreted as having an ideal or excessively formal meaning.

Terms or words used in this specification and claims should not be construed as limited to their common or dictionary meanings, and based on the principle that the inventor may appropriately define the concept of terms in order to explain his or her invention in the best way, the terms or words must be interpreted with a meaning and concept consistent with the technical idea of the present disclosure. In addition, if there is no other definition in the technical and scientific terms used herein, they have the meaning commonly understood by those skilled in the art, and any descriptions of known functions and configurations that may unnecessarily obscure the gist of the present disclosure in the following description and the accompanying drawings will be omitted. The drawings introduced below are provided as examples to sufficiently convey the idea of the present disclosure to those skilled in the art. Accordingly, the present disclosure is not limited to the drawings presented below and may be embodied in other forms. Also, like reference numerals refer to like elements throughout the specification. It should be noted that like elements in the drawings are represented by like symbols in all drawings.

Hereinafter, a preferred embodiment of the present disclosure will be described in detail with reference to the accompanying drawings. The accompanying drawings are not drawn to scale, and like reference numbers in each drawing refer to like elements.

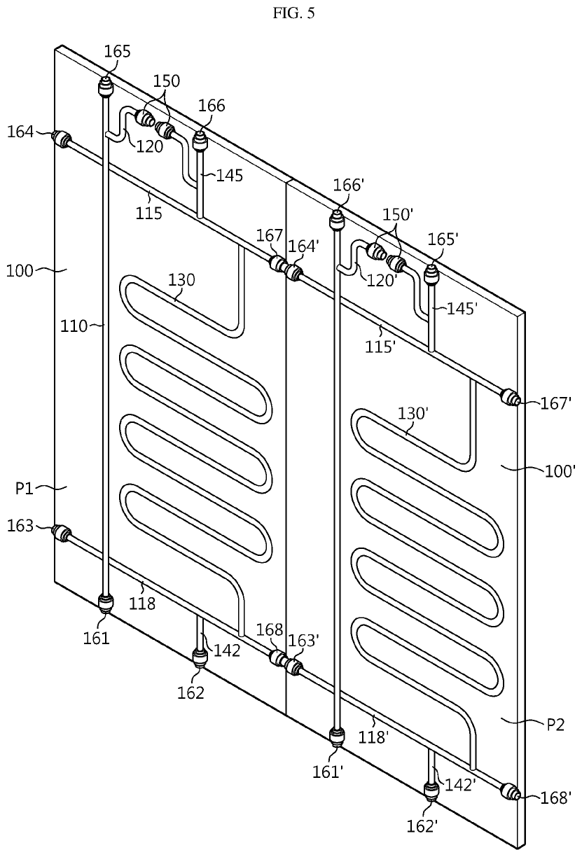

FIG. 5 is a schematic plan view showing a self-assembly hot water mat with a parallel flow according to a preferred embodiment of the present disclosure in which two unit hot water mats 100 and 100′ are coupled.

Referring to FIG. 5, the self-assembly hot water mat with a parallel flow according to an embodiment of the present disclosure is configured by assembling two unit hot water mats. First, the basic configuration of the unit hot water mat according to an embodiment of the present disclosure is explained based on the unit hot water mat P₁ (100) among the two unit hot water mats P₁ (100) and P₂ (100′). At this time, the remaining unit hot water mat P₂ (100′) also symmetrically has the same configuration as the unit hot water mat P₁ (100).

In the present disclosure, the term ‘unit hot water mat’ refers to a single hot water mat before assembly, as indicated by reference numeral 100 or 100′ in FIG. 5, and the term ‘self-assembly hot water mat’ refers to a hot water mat in which two or more unit hot water mats are assembled as shown in FIGS. 5 to 7.

The unit hot water mat P₁ (100) preferably has a rectangular shape, and includes a plurality of ON/OFF valves 161 to 168, in which two values are formed in a pair on each of four sides, a heating pipe 130 formed in a certain pattern (e.g., zigzag pattern) to allow a hot water introduced from a hot water boiler 200 to pass in a certain pattern in order to heat the surface of the hot water mat, a first main pipe 110 configured to allow the hot water introduced from the hot water boiler 200 to flow in the first direction (e.g., long side direction or length direction) of the rectangular mat, a second main pipe 115 configured to allow the hot water in the first direction to flow in the second direction (e.g., short side direction or width direction) of the rectangular mat, a return pipe 118 configured to collect the hot water passing through the heating pipe 130 in the second direction and return the hot water to the hot water boiler (BLR) 200, a first connected pipe 142 connected in the first direction to the return pipe 118 and a second connected pipe 145 connected in the first direction to the second main pipe 115 in order to connect the heating pipes 130 of at least two unit hot water mats adjacent to each other in the first direction in series, a bypass pipe 120 configured to convert the hot water in the first direction of the first main pipe 110 into a hot water in the second direction of the main pipe 115 by connecting the first main pipe 110 and the second connected pipe 145 and deliver the hot water to the heating pipe 130, and a connection connector 150 installed on the bypass pipe 120.

In the case of a unit hot water mat (hereinafter, referred to as a “departure unit hot water mat”) that is directly connected to the hot water boiler 200, the first connected pipe 142 connects the return pipe 118 and the hot water boiler 200. Also, one end of the first main pipe 110 of the departure unit hot water mat is directly connected to the hot water boiler 200.

Therefore, in the case of the self-assembly hot water mat according to the present disclosure, the hot water introduced from the hot water boiler 200 flows through the first main pipe 110, the bypass pipe 120 and the second main pipe 115 of the departure unit hot water mat, passes in parallel through the heating pipes of the plurality of unit hot water mats that are directly or indirectly connected to the departure unit hot water mat, is collected in the return pipe 118 of the departure unit hot water mat, and returns to the hot water boiler 200 through the first connected pipe 142.

The hot water introduced from the hot water boiler 200 flows through the first main pipe 110 in the first direction and then changes direction through the bypass pipe 150 to form a serial flow that flows through the second main pipe 115 in the second direction. The hot water that reaches the second main pipe 115 in this way is divided into at least two hot water flows in the second main pipe 115 and then branched into several ways.

In the present disclosure, when several unit hot water mats are assembled to form a self-assembly hot water mat of an N×M array (N row-M column matrix) (where N and M are natural numbers of 1 or more), the first main pipes of the unit hot water mats that constitute the 1^{st} column are connected to each other in series to form a main flow in the first direction, and the second main pipes of the unit hot water mats that constitute the 1^{st} row are connected to each other in series to form a main flow in the second direction. In addition, the main flow in the second direction is branched into a plurality of parallel flow paths to form a plurality of branch flows.

The ON/OFF valves 161 to 168 are valves that close the flow path to the OFF state ordinarily and open the flow path to the ON state when the neighboring ON/OFF valves 161 to 168 are connected to each other. The ON/OFF valves 161 to 168 are installed at both ends of the first main pipe 110, both ends of the second main pipe 115, both ends of the return pipe 118, and an end in one direction of the first and second connected pipes 142 and 145, respectively.

Therefore, in a state where the unit hot water mat 100 is singly connected to the hot water boiler (BLR) 200), among the ON/OFF valves 161 to 168, ON/OFF valves 163 to 168 other than the ON/OFF valves 161, 162) installed at the first main pipe 110 and the first connected pipe 142 directly connected to the hot water boiler 200 are maintained in the OFF state.

The connection connector 150 is installed on the bypass pipe 120 to open or close the hot water flow path of the bypass pipe 120. If the coupling of the connection connectors 150 is in the OFF state, the flow path of the bypass pipe 120 is maintained in the closed state. That is, since the connection connectors 150 are not coupled to each other ordinarily, the hot water flow path of the bypass pipe 120 is blocked in the closed state. Meanwhile, by coupling the connection connectors 150 with each other, the flow path of the bypass pipe 120 is opened. As a result, the hot water flow in the first direction of the first main pipe 110 may be converted to the hot water flow in the second direction of the second main pipe 115 through the bypass pipe 120 and be introduced into the heating pipe 130. Therefore, when the coupling of the connection connectors 150 is in the OFF state, the flow paths of the first main pipe 110 and the second main pipe 115 are not connected.

In the present disclosure, when several unit hot water mats are assembled to form a self-assembly hot water mat of an N×M array (N row-M column matrix) (where N and M are natural numbers of 1 or more), only the coupling of the connection connector 150 of the unit hot water mat at the 1^{st} row and the 1^{st} column is in the ON state, and the coupling of the connection connectors 150 of the remaining unit hot water mats are all in the OFF state. That is, only the first main pipe 110 and the second main pipe 115 of the unit hot water mat at the 1^{st} row and the 1^{st} column are connected, and the first main pipes 110 and the second main pipes 115 of all remaining unit hot water mats are not connected to each other. Therefore, the hot water flow in the first main pipes connected in series of the unit hot water mats that constitute the 1^{st} column forms a serial flow in the first direction, and the hot water flow of the second main pipes connected in series of the unit hot water mats that constitute the 1^{st} row forms a serial flow in the second direction. In addition, the serial hot water flow in the first direction is converted to the serial hot water flow in the second direction through the bypass pipe of the unit hot water mat at the 1^{st} row and the 1^{st} column, and the serial hot water flow in the second direction converted in this way is branched at the point, which is connected to the heating pipe of each of the unit hot water mats that constitute the 1^{st} row, to form several parallel hot water flows.

The heating pipe 130 may be formed in various patterns at the center of the unit hot water mat 100, which is a spaced space between the second main pipe 115 and the return pipe 118. The heating pipe 130 forms a hot water flow path to warm the upper surface of the hot water mat, and desirably has a pattern that is capable of increasing heating efficiency per unit area. The heating pipe 130 may have various patterns, such as a zigzag pattern or a whirlpool pattern. As the pattern of the heating pipe 130, it is most desirable to apply a zigzag pattern as shown in FIG. 5 for smooth flow of the hot water and heating efficiency.

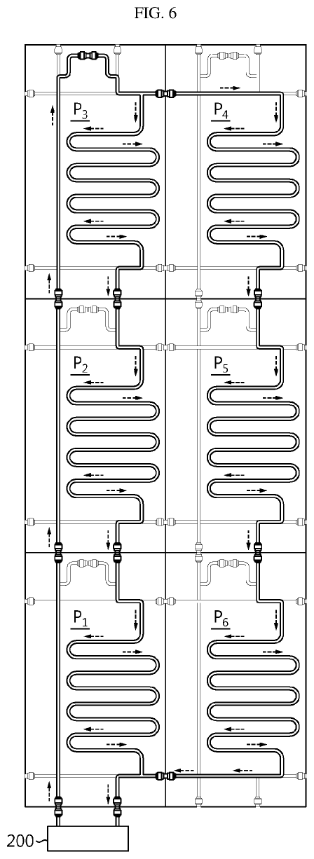

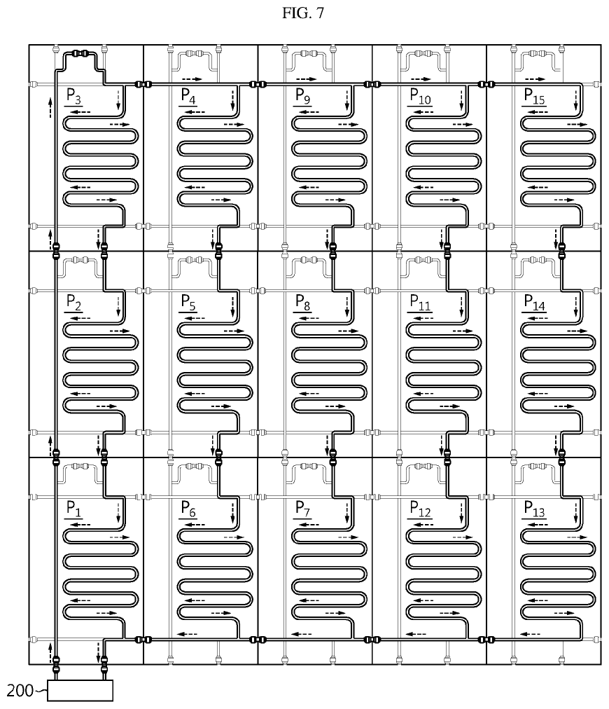

The parallel hot water flow according to the present disclosure constitutes a form in which a plurality of branch hot water flow paths are connected in parallel to one main hot water flow path. For example, FIG. 6 shows a parallel hot water flow in which two branch hot water flow paths are connected in parallel to one main hot water flow path in the second direction, and FIG. 7 shows a parallel hot water flow in which five branch hot water flow paths are connected in parallel to one main hot water flow path in the second direction. In addition, in both FIGS. 6 and 7, the heating pipes of three unit hot water mats are connected in series to each branch hot water flow path in the first direction.

In FIG. 6, a total of 6 unit hot water mats P₁ to P₆ are assembled in a 3×2 array (3 row-2 column matrix) to form a 3×2 parallel hot water flow in which the serial flow where the heating pipes of three unit hot water mats are connected is branched into two parallel flows. In addition, in FIG. 7, a total of 15 unit hot water mats P₁ to P₁₅ are assembled in a 3×5 array (3 row-5 column matrix) to form a 3×5 parallel hot water flow in which the serial flow where the heating pipes of three unit hot water mats are connected is branched into five parallel flows.

At this time, the first main pipes of the unit hot water mats that constitute the 1^{st} column and the second main pipes of the unit hot water mats that constitute the 1^{st} row in the M×N matrix (N row-M column matrix) (where N and M are natural numbers of 1 or more) of the self-assembly hot water mat are connected through the bypass pipe of the unit hot water mat disposed at the 1^{st} row and the 1^{st} column to configure the main flow path of the parallel hot water flow. In other words, in order to connect the first main pipes of the unit hot water mats that constitute the 1^{st} column, the ON/OFF valves 161, 165 installed on the first main pipe 110 are connected to each other to open the serial main hot water flow path in the first direction. In addition, in order to connect the second main pipes of the unit hot water mats that constitute the 1^{st} row, the ON/OFF valves 164, 167 installed on the second main pipe 115 are connected to each other to open the serial main hot water flow path in the second direction. Also, in order to connect the return pipes of the unit hot water mats that constitute the M^{th} row, the ON/OFF valves 163, 168 installed on the return pipe 115 are connected to each other to open the return hot water flow path in the second direction. In addition, the connection connectors installed on the bypass pipe of the unit hot water mat at the 1^{st} row and the 1^{st} column are coupled to open the hot water flow path of the bypass pipe.

First, referring to FIG. 5, the parallel hot water flow will be explained in the case where two unit hot water mats P₁ (100) and P₂ (100′) are assembled.

Among the ON/OFF valves of the unit hot water mat P₁ (100), the ON/OFF valves 161 and 162 installed on the first main pipe 110 and the first connected pipe 142, which are directly connected to the hot water boiler 200, are opened. Also, the main hot water flow path in the second direction is opened by coupling the ON/OFF valves 167 and 164′ to each other to connect the second main pipes 115, 115′ of the unit hot water mats P₁ (100) and P₂ (100′). In addition, the return hot water flow path in the second direction is opened by coupling the ON/OFF valves 168 and 163′ to each other to connect the return pipes 118, 118′ of the unit hot water mats P₁ (100) and P₂ (100′). Also, the remaining ON/OFF valves 163, 164, 165, 166, 161′, 162′, 165′, 166′, 167′, 168′ are maintained in the OFF state. Also, the connection connector 150 of the unit hot water mat P₁ (100) is coupled to open the hot water flow path of the bypass pipe 120, and the connection connector 150′ of the unit hot water mat P₂ (100′) is not coupled to close the hot water flow path of the bypass pipe 120′.

In this state, if the hot water boiler 200 is operated, the hot water heated by the hot water boiler 200 passes through the first main pipe 110 and bypass pipe 120 of the unit hot water mat P₁ (100), reaches the second main pipe 115, and then is branched into two hot water flow paths so that one flows to the heating pipe 130 of unit hot water mat P₁ (100) and the other flows to the heating pipe 130′ through the second main pipe 115′ of the unit hot water mat P₂ (100′).

The hot water flow paths branched to the heating pipes 130 and 130′ of the unit hot water mats P₁ (100) and P₂ (100′), respectively, are collected at the return pipe 118 of the unit hot water mat P₁ (100) and then returns back to the hot water boiler 200 through the first connected pipe 142.

In this way, the self-assembly hot water mat of FIG. 5 according to the present disclosure forms a parallel hot water flow including two branch hot water flow paths (each branch hot water flow path is configured with one heating pipe), which converts the hot water introduced in the first direction through the hot water boiler 200 into the second direction, then divides the hot water into two branch flow paths to flow in the first direction according to a certain pattern, then collects the hot water in the second direction, and returns to the hot water boiler 200.

FIG. 6 is a schematic plan view showing a self-assembly hot water mat according to the present disclosure in which unit hot water mats P₁ to P₆ are assembled into a 3×2 matrix.

Referring to FIG. 6, the hot water from the hot water boiler 200 sequentially passes through the first main pipes of the unit hot water mats P₁, P₂, P₃ at the 1^{st} column, reaches the second main pipe of the unit hot water mat P₃ at the 1^{st} row and the 1^{st} column through the bypass pipe of the unit hot water mat P₃ at the 1^{st} row and the 1^{st} column, and is branched into two paths, so that one flows in series through the heating pipes of the unit hot water mats P₃, P₂, P₁ of the 1^{st} column in order and the other flows in series through the second main pipe of the unit hot water mat P₄ at the 1^{st} row and the 2nd column and through the heating pipes of the unit hot water mats P₄, P₅, P₆ at the 2nd column in order.

The serial hot water flow branched to the heating pipes of the unit hot water mats P₃, P₂, P₁ at the 1^{st} column and the serial hot water flow branched to the heating pipes of the unit hot water mats P₄, P₅, P₆ at the 2nd column are collected in the return pipe of the unit hot water mat P₁ at the 3rd row and the 1^{st} column (departure unit hot water mat) and returns to the hot water boiler 200 through the first connected pipe of the unit hot water mat P₁.

In this way, the self-assembly hot water mat of FIG. 6 according to the present disclosure forms a parallel hot water flow including two branch hot water flow paths (each branch hot water flow path is configured by connecting three heating pipes in series), which converts the hot water introduced in the first direction through the hot water boiler 200 into the second direction, divides the hot water into two branch flow paths to flow in the first direction according to a certain pattern, and then is collected in the second direction and returned to the hot water boiler 200.

FIG. 7 is a schematic plan view showing a self-assembly hot water mat according to the present disclosure, in which fifteen unit hot water mats are assembled into a 3×5 matrix.

Referring to FIG. 7, the hot water from the hot water boiler 200 sequentially passes through the first main pipes of the unit hot water mats P₁, P₂, P₃ at the 1^{st} column, and is branched into two paths at the second main pipe of the unit hot water mat P₃ at the 1^{st} row and the 1^{st} column through the bypass pipe of the unit hot water mat P₃ at the 1^{st} row and the 1^{st} column, so that one flows in series through the heating pipes of the unit hot water mats P₃, P₂, P₁ at the 1^{st} column in order and the other flows to the second main pipe of the unit hot water mat P₄ at the 1^{st} row and the 2^{nd} column.

The hot water introduced into the second main pipe of the unit hot water mat P₄ at the 1^{st} row and the 2^{nd} column is branched again into two paths at the second main pipe of the unit hot water mat P₄, so that one flows in series through the heating pipes of the unit hot water mats P₄, P₅, P₆ at the 2^{nd} column in order and the other flows to the second main pipe of unit hot water mat P₉ at the 1^{st} row and the 3rd column.

The hot water introduced into the second main pipe of the unit hot water mat P₉ at the 1^{st} row and the 3^{rd} column is branched again into two paths at the second main pipe of the unit hot water mat P₉, so that one flows in series through the heating pipes of the unit hot water mats P₉, P₈, P₇ at the 3^{rd} column in order and the other flows to the second main pipe of the unit hot water mat P₁₀ at the 1^{st} row and the 4th column.

The hot water introduced into the second main pipe of the unit hot water mat P₁₀ at the 1^{st} row and the 4th column is branched again into two paths at the second main pipe of the unit hot water mat P₁₀, so that one flows in series through the heating pipes of the unit hot water mats P₁₀, P₁₁, P₁₂ at the 4th column in order and the other passes in series through the second main pipe of the unit hot water mat P₁₅ at the 1^{st} row and the 5th column and through the heating pipes of the unit hot water mats P₁₅, P₁₄, P₁₃ at the 5th column in order.

The serial hot water flow branched to the heating pipes of the unit hot water mats P₃, P₂, P₁ at the 1^{st} column, the serial hot water flow branched to the heating pipes of the unit hot water mats P₄, P₅, P₆ at the 2^{nd} column, the serial hot water flow branched to the heating pipes of the unit hot water mats P₉, P₈, P₇ at the 3^{rd} column, the serial hot water flow branched to the heating pipes of the unit hot water mats P₁₀, P₁₁, P₁₂ at the 4^{th} column, and the serial hot water flow branched to the heating pipes of the unit hot water mats P₁₅, P₁₄, P₁₃ at the 5^{th} column are all collected into the return pipe of the unit hot water mat P₁ at the 3rd row and the 1^{st} column (departure unit hot water mat) and returns to the hot water boiler 200 through the first connected pipe of to the unit hot water mat P₁.

In this way, the self-assembly hot water mat of FIG. 7 according to the present disclosure forms a parallel hot water flow including five branch hot water flow paths (each branch hot water flow path is configured by connecting three heating pipes in series), which converts the hot water introduced in the first direction through the hot water boiler 200 into the second direction, divides the hot water into five branch flow paths to flow in the first direction according to a certain pattern, and then is collected in the second direction and returned to the hot water boiler 200.

The present disclosure has been described in detail. However, it should be understood that the detailed description and specific examples, while indicating preferred embodiments of the disclosure, are given by way of illustration only, since various changes and modifications within the scope of the disclosure will become apparent to those skilled in the art from this detailed description.

### INDUSTRIAL APPLICABILITY

The self-assembly hot water mat with a parallel flow according to the present disclosure may be used for various purposes, such as general home bedding, a heating mat for various medical institutions such as nursing hospitals, or a heated cushion for offices.

What is claimed is:

1. A unit hot water mat of a self-assembly hot water mat, which forms a parallel flow by assembling at least two unit hot water mats, the unit hot water mat comprising:
a heating pipe arranged in a predetermined pattern to heat a surface of the unit hot water mat by passing a hot water inflowed from a hot water boiler in the predetermined pattern;
a first main pipe configured to flow the hot water inflowed from the hot water boiler to a first direction;
a second main pipe connected to the heating pipe to flow the hot water from the first direction to a second direction and deliver the hot water to the heating pipe;
a return pipe installed to be spaced apart from the second main pipe by a predetermined distance in the first direction and connected to the heating pipe to flow the hot water circulated through the heating pipe to the second direction and return to the hot water boiler; and
a bypass pipe configured to connect the first main pipe and the second main pipe to convert the hot water having the first direction to hot water having the second direction,
wherein the heating pipe is formed in a separated space between the second main pipe and the return pipe.

2. The unit hot water mat according to claim 1, further comprising:
a first connected pipe connected in the first direction to the return pipe and a second connected pipe connected in the first direction to the second main pipe to form a serial hot water flow path between heating pipes of unit hot water mats adjacent to each other in the first direction.

3. The unit hot water mat according to claim 2,
wherein the bypass pipe converts the hot water having the first direction in the first main pipe into the hot water having the second direction in the second main pipe by connecting the first main pipe and the second connected pipe.

4. The unit hot water mat according to claim 3, further comprising:
an ON/OFF valve installed at both ends of the first main pipe, both ends of the second main pipe, both ends of the return pipe, and an end of the first and second connected pipes, respectively,
wherein the ON/OFF valve opens a flow path by coupling two corresponding ON/OFF valves.

5. The unit hot water mat according to claim 4,
wherein a connection connector is installed on the bypass pipe to open or close the hot water flow path.

6. The unit hot water mat according to claim 5,
wherein the first direction and the second direction are perpendicular to each other.

7. The unit hot water mat according to claim 6,
wherein the first connected pipe is directly connected to the hot water boiler.

8. The unit hot water mat according to claim 7,
wherein the heating pipe is arranged in a zigzag pattern along the first direction at a center of the unit hot water mat between the second main pipe and the return pipe.

9. The unit hot water mat according to claim 7,
wherein the unit hot water mat is a rectangular, the first main pipe is installed in the first direction which is a long side direction of the rectangle, and the second main pipe and the return pipe are installed in the second direction which is a short side direction of the rectangle to be spaced apart by a predetermined distance from each other.

10. The unit hot water mat according to claim 9,
wherein a pair of ON/OFF valves are installed on each of four sides of the rectangular.

11. A self-assembly hot water mat with a parallel flow, which have an M×N matrix array (M and N are natural numbers of 1 or more) by assembling at least two unit hot water mats according to any one of claims 5 to 10,
wherein a main hot water flow path having the first direction is formed by coupling the ON/OFF valves installed at both ends of the first main pipe of unit hot water mats that constitute the 1^{st} column of the M×N matrix,
wherein the ON/OFF valve installed at one end of the first main pipe of the unit hot water mat at the M^{th} row and the 1^{st} column is connected to the hot water boiler,
wherein a main hot water flow path having the second direction is formed by coupling the ON/OFF valves installed at both ends of the second main pipes of unit hot water mats that constitute the 1^{st} row of the M×N matrix,
wherein a return hot water flow path having the second direction is formed by coupling the ON/OFF valves installed at both ends of the return pipes of unit hot water mats that constitute the M^{th} row of the M×N matrix,
wherein the ON/OFF valve installed at one end of the first connected pipe of the unit hot water mat at the M^{th} row and the 1^{st} column is connected to the hot water boiler, and
wherein a bypass hot water flow path is opened by coupling only the connection connector installed on the bypass pipe of the unit hot water mat at the 1^{st} row and the 1^{st} column.

12. The self-assembly hot water mat with a parallel flow according to claim 11,
wherein the hot water flowing through the main hot water flow path having the first direction inflowed from the hot water boiler is converted to the hot water flowing through the main hot water flow path having the second direction, then is divided into the n (n is a natural number of 2 or more) number of branch flow paths to flow in the first direction according to the predetermined pattern, and then is collected in the second direction and returned to the hot water boiler.

13. The self-assembly hot water mat with a parallel flow according to claim 12,
wherein each of the n number of branch hot water flow paths is formed a serial heating flow path in which the m (m is a natural number of 1 or more) number of heating pipes are connected in series.

14. The self-assembly hot water mat with a parallel flow according to claim 13,
wherein the M×N matrix array forms a parallel hot water flow by connecting a N number of serial heating flow paths, in which a M number of heating pipes are connected in series, to each other in parallel.
